(19) United States
(12) Patent Application Publication
(10) Pub. No.: US 2021/0138724 A1
(43) Pub. Date: May 13, 2021

(54) THREE-DIMENSIONAL PRINTING

(71) Applicant: HEWLETT-PACKARD DEVELOPMENT COMPANY, L.P., Spring, TX (US)

(72) Inventors: Rachael Donovan, San Diego, CA (US); Yi Feng, San Diego, CA (US); Michael A. Novick, San Diego, CA (US); Bernardo A. Gutierrez, San Diego, CA (US); Mariya Gelman, San Diego, CA (US); Geoffrey Schmid, San Diego, CA (US); Carolin Fleischmann, San Diego, CA (US)

(21) Appl. No.: 16/605,113

(22) PCT Filed: Mar. 23, 2018
(86) PCT No.: PCT/US18/24109

§ 371 Date: Oct. 14, 2019

(51) Int. Cl. B29C 64/165; B29C 64/268; B29C 64/314; B33Y 70/00; B29C 64/218

(52) U.S. Cl. CPC B29C 64/165; B29C 64/268; B33Y 10/00; B33Y 70/00; B29C 64/218; B29C 64/314

(57) ABSTRACT

An example of a three-dimensional (3D) printing kit includes a build material composition and a fusing agent to be applied to at least a portion of the build material composition during 3D printing. The build material composition includes a polyether block amide polymer. The fusing agent includes an energy absorber to absorb electromagnetic radiation to melt or fuse the at least a portion of the polyether block amide polymer.

### BACKGROUND

Three-dimensional (3D) printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final part. Some 3D printing methods use chemical binders or adhesives to bind build materials together. Other 3D printing methods involve at least partial curing, thermal merging/fusing, melting, sintering, etc. of the build material, and the mechanism for material coalescence may depend upon the type of build material used. For some materials, at least partial melting may be accomplished using heat-assisted extrusion, and for some other materials (e.g., polymerizable materials), curing or fusing may be accomplished using, for example, ultra-violet light or infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a method for 3D printing;

FIG. 2 is a flow diagram illustrating another example of a method for 3D printing;

FIGS. 3A through 3E are schematic and partially cross-sectional cutaway views depicting the formation of a 3D part using an example of the 3D printing method disclosed herein;

FIG. 4 is a simplified isometric and schematic view of an example of a 3D printing system disclosed herein;

FIG. 5 is a graph showing b* value as a function of generation number for an example build material composition at different weight ratios of recycled build material composition to fresh build material composition, with the b* value shown on the y-axis, and the generation number shown on the x-axis;

FIG. 6A is a graph showing ultimate tensile strength as a function of generation number (at a weight ratio of recycled build material composition to fresh build material composition of 80:20) for S2 specimens formed from the example build material composition, with the ultimate tensile strength (in MPa) shown on the y-axis, and the S2 specimens identified on the x-axis by fresh (i.e., fresh build material composition was used to form the S2 specimen) or the generation number of the build material composition used to form the S2 specimen; and

FIG. 6B is a graph showing elongation at break as a function of generation number (at a weight ratio of recycled build material composition to fresh build material composition of 80:20) for S2 specimens formed from the example build material composition, with the elongation at break (in %) shown on the y-axis, and the S2 specimens identified on the x-axis by fresh (i.e., fresh build material composition was used to form the S2 specimen) or the generation number of the build material composition used to form the S2 specimen.

### DETAILED DESCRIPTION

Some examples of three-dimensional (3D) printing may utilize a fusing agent (including an energy absorber) to pattern polymeric build material. In these examples, an entire layer of the polymeric build material is exposed to radiation, but the patterned region (which, in some instances, is less than the entire layer) of the polymeric build material is fused/coalesced and hardened to become a layer of a 3D part. In the patterned region, the fusing agent is capable of at least partially penetrating into voids between the polymeric build material particles, and is also capable of spreading onto the exterior surface of the polymeric build material particles. This fusing agent is capable of absorbing radiation and converting the absorbed radiation to thermal energy, which in turn fuses/coalesces the polymeric build material that is in contact with the fusing agent. Fusing/coalescing causes the polymeric build material to join or blend to form a single entity (i.e., the layer of the 3D part). Fusing/coalescing may involve at least partial thermal merging, melting, binding, and/or some other mechanism that coalesces the polymeric build material to form the layer of the 3D part.

In the examples disclosed herein, this 3D printing method is utilized with a polyether block amide polymer in the build material composition. The polyether block amide polymer is relatively amorphous (i.e., has low crystallinity), and thus has a relatively wide melting range, i.e., from about 130° C. to about 170° C. With the polymer's low crystallinity, it has been found that the processing temperature used in the method can be below the crystallization temperature, rather than between the crystallization temperature and the onset-of-melt temperature. As such, in the examples disclosed herein, the printing temperature parameters are selected to be at or below 125° C.

The polyether block amide polymer is also reflective of the radiation used in the 3D printing method. The reflectively of the polyether block amide polymer does not interfere with the absorptivity of the fusing agent used in the 3D printing method. As such, the patterned polyether block amide polymer is able to fuse/coalesce to from a mechanically strong 3D part, while the non-patterned polyether block amide polymer remains non-fused/non-coalesced when exposed to the radiation. It has been found that the non-patterned polyether block amide polymer can be easily removed from the 3D part and recycled.

Build Material Compositions

Disclosed herein is a build material composition that includes the polyether block amide polymer. In some examples, the build material composition consists of the polyether block amide polymer. In other examples, the build material composition may include additional components, such as an antioxidant, a whitener, an antistatic agent, a flow aid, or a combination thereof.

The polyether block amide polymer includes hard polyamide blocks, which give the polymer and the 3D printed part formed therefrom strength, and soft polyether blocks, which give the polymer and the 3D printed part formed therefrom flexibility. In some examples, the polyether block amide polymer and/or the 3D printed part formed therefrom may also have comparable or lower density, comparable or greater flexibility, comparable or improved impact resistance, comparable or improved energy return, and/or comparable or improved fatigue resistance, as compared to, respectively, the density, flexibility, impact resistance, energy return, and fatigue resistance of other thermoplastic elastomers and/or 3D parts formed therefrom. Further, in some of these examples, polyether block amide polymer and the 3D printed part formed therefrom may maintain these properties at low temperatures (e.g., −40° C.). In some examples, the polyether block amide polymer and the 3D printed part formed therefrom may have a density of about 1.00 g/cm³; a water absorption at equilibrium (i.e., 23° C. and 50% relative air humidity (RH)) ranging from about 0.4% to about 0.8%; a water absorption at saturation (i.e., 23° C. and 24 hours in water) ranging from about 0.9% to about 1.2%; a Shore D hardness ranging from about 25 to about 72; a flexural modulus ranging from about 12 MPa to about 513 MPa; an elongation at beak ranging from about 300% to about 750%; an impact resistance (Charpy, notched) of no break; and/or an abrasion resistance (10 N/40 m) ranging about 55 mm³ to about 130 mm³. These properties may depend upon the weight ratio of soft to hard may segments in the polyether block amide polymer. Some examples of the polyether block amide polymer may also have electrical properties (e.g., surface resistivity, volume resistivity, etc.), which may be exhibited by the 3D printed part formed therefrom.

The polyether block amide polymer may be produced by polycondensation of a carboxylic acid polyamide (e.g., polyamide 6, polyamide 11, polyamide 12, etc.) with an alcohol termination polyether (e.g., polytetramethylene glycol (PTMG), polyethylene glycol (PEG), etc.). Examples of the polyether block amide polymer may have the chemical formula:

HO—(CO-PA-CO—O-PE-O)ₙ—H,

where PA is the polyamide block, PE is the polyether block, where n varies depending upon the molecule weight of the material.

Examples of the polyether block amide polymer include PEBAX® resins (available from Arkema Inc.) and VESTAMID® E (available from Evonik Industries).

In some examples, the polyether block amide polymer has a melting range of from about 130° C. to about 175° C. In some other examples, the polyether block amide polymer has a melting range of from about 134° C. to about 174° C.

In some examples, the polyether block amide polymer does not substantially absorb radiation having a wavelength within the range of 400 nm to 1400 nm. In other examples, the polyether block amide polymer does not substantially absorb radiation having a wavelength within the range of 800 nm to 1400 nm. In still other examples, the polyether block amide polymer does not substantially absorb radiation having a wavelength within the range of 400 nm to 1200 nm. In these examples, the polyether block amide polymer may be considered to reflect the wavelengths at which the polyether block amide polymer does not substantially absorb radiation. The phrase “does not substantially absorb” means that the absorptivity of the polyether block amide polymer at a particular wavelength is 25% or less (e.g., 20%, 10%, 5%, etc.).

In some examples, the polyether block amide polymer may be in the form of a powder. In other examples, the polyether block amide polymer may be in the form of a powder-like material, which includes, for example, short fibers having a length that is greater than its width. In some examples, the powder or powder-like material may be formed from, or may include, short fibers that may, for example, have been cut into short lengths from long strands or threads of material.

The powder or powder-like material of the polyether block amide polymer may have an avalanche angle at room temperature (e.g., a temperature ranging from about 18° C. to about 25° C.) that is less than or equal to 60°. The avalanche angle is the angle of the powder/powder-like material at the maximum power prior to the start of an avalanche occurrence. It may be desirable for the polyether block amide polymer to have an avalanche angle at room temperature that is less than or equal to 60° so that the polyether block amide polymer has sufficient flowability and is able to be spread into build material layers. In an example, the polyether block amide polymer has an avalanche angle at room temperature that is less than 55°. In another example, the polyether block amide polymer has an avalanche angle at room temperature that is about 54°. In these examples, the avalanche angle may be measured in an instrument, such as the REVOLUTION™ Powder Analyzer from Mercury Scientific Inc. This type of instrument includes a drum that rotates the powder (at a user selected revolution rate and for a user selected time), and collects digital images of the powder during the rotation process. This instrument measures the behavior of the powder from the digital images. In an example, the revolution rate may be 0.6 RPM.

The relative solution viscosity (or “solution viscosity” or “relative viscosity” for brevity) of the polyether block amide polymer correlates to the molecular weight (weight average or number average) of the polyether block amide polymer. In an example, the polyether block amide polymer has a solution viscosity at 25° C. ranging from about 1.55 to about 1.80, based on American Society for Testing Materials (ASTM) standards using m-cresol as the solvent. In another example, the polyether block amide polymer has a solution viscosity at 25° C. ranging from about 1.70 to about 1.80, based on American Society for Testing Materials (ASTM) standards using m-cresol as the solvent. In still another example, polyether block amide polymer has a solution viscosity at 25° C. ranging from about 1.55 to about 1.6. In yet another example, polyether block amide polymer has a solution viscosity at 25° C. of 1.55. In yet another example, polyether block amide polymer has a solution viscosity at 25° C. of 1.70. In yet another example, polyether block amide polymer has a solution viscosity at 25° C. of 1.75.

The solution viscosity of the polyether block amide polymer may be measured according to American Society for Testing Materials (ASTM) standards using m-cresol as the solvent. Briefly, solution viscosity is determined by combining 0.5 wt % of the polyether block amide polymer with 99.5 wt % of m-cresol (also known as 3-methylphenol) and measuring the viscosity of the mixture at room temperature (e.g., 25° C.) compared to the viscosity of pure m-cresol. The viscosity measurements are based on the time it takes for a certain volume of the mixture or liquid to pass through a capillary viscometer under its own weight or gravity. The solution viscosity is defined as a ratio of the time it takes the mixture (including the polyether block amide polymer) to pass through the capillary viscometer to the time it takes the pure liquid takes to pass through the capillary viscometer. As the mixture is more viscous than the pure liquid and a higher viscosity increases the time it takes to pass through the capillary viscometer, the solution viscosity is greater than 1. As an example, the mixture of 0.5 wt % of the polyether block amide polymer in 99.5 wt % of the m-cresol may take about 180 seconds to pass through the capillary viscometer, and m-cresol may take about 120 seconds to pass through the capillary viscometer. In this example, the solution viscosity is 1.5 (i.e., 180 seconds divided by 120 seconds). Further details for determining solution viscosity under this measurement protocol are described in International Standard ISO 307, Fifth Edition, 2007 May 15, incorporated herein by reference in its entirety.

When the solution viscosity at 25° C. of the polyether block amide polymer ranges from about 1.70 to about 1.80, the interlayer adhesion strength of 3D printed parts formed from the polyether block amide polymer is greater than the interlayer adhesion strength of 3D printed parts formed from a polyether block amide polymer with a lower solution viscosity at 25° C. This greater interlayer adhesion strength of the 3D parts may result in increased ultimate tensile strength, elongation at break, and/or tear strength of the 3D printed parts. The solution viscosity depends upon the length of the soft and hard segments in the polyether block amide polymer. It is believed that, with any base resin, the interlayer adhesion of the 3D printed part will increase as the solution viscosity of the base resin increases until a peak viscosity is reached. After the peak viscosity is reached, the viscosity may continue to increase, however, the interlayer adhesion will decrease. It is believed that the ultimate tensile strength, elongation at break, and/or tear strength of 3D printed parts formed from the polyether block amide polymer may increase until the peak viscosity is reached. As such, when the solution viscosity at 25° C. of the polyether block amide polymer ranges from about 1.70 to about 1.80, the interlayer adhesion strength of 3D printed parts formed from the polyether block amide polymer may also be greater than the interlayer adhesion strength of some 3D printed parts formed from a polyether block amide polymer with a solution viscosity at 25° C. that is higher than the peak viscosity.

Examples of the polyether block amide polymer may also be stable and/or non-reactive. As used herein, the terms “stable” and “non-reactive” refer to a material's ability to remain substantially unchanged over time and/or at elevated temperatures. To determine the stability/non-reactivity of the polyether block amide polymer, the change in solution viscosity may be measured over time, and the percentage of solution viscosity change may be determined. When the change in solution viscosity is within 4% of the original solution viscosity, the polyether block amide polymer may be considered to be substantially unchanged.

To facilitate the measurement of the change in solution viscosity, the polyether block amide polymer may be subjected to an aging process for a predetermined amount of time at a specific temperature profile. For example, the aging process may include exposing the polyether block amide polymer to an air environment that has a temperature of about 125° C. for about 125 hours. As such, the environment used during the aging process may be similar to or slightly harsher than the environment to which the polyether block amide polymer may be exposed during 3D printing. As other examples, a temperature of 110° C., or a temperature of 120° C., or another temperature may be used, as long as the temperature used is below the melting range of the polyether block amide polymer used). The temperature used during the aging process may be similar to the temperature(s) to which the non-patterned build material may be exposed during 3D printing (e.g., a printbed temperature/pre-heating temperature during printing ranging from about 110° C. to about 125° C.). As still other examples, a time period of 5 hours, or a time period of 12.5 hours, or a time period 25 hours, or a time period of 50 hours, or a time period of 75 hours, or a time period of 112.5 hours, or another time period may be used. The time period of the aging process may be similar to the time period of the 3D printing process (or multiple 3D printing processes in which reused/recycled build material may be used). In other examples, the aging time may be extended to compensate for a printing process temperature that is higher than the aging temperature. The conditions associated with the aging process may, without melting the polyether block amide polymer, facilitate the change in solution viscosity that the polyether block amide polymer may have exhibited as a result of being exposed to the 3D printing process that utilizes the fusing agent. It is to be understood that the change that the polyether block amide polymer would have exhibited as a result of being exposed to the 3D printing process may be less than the change resulting from the aging process facilitates depending, in part, on the environment, the temperature, and the time period of the 3D printing process.

The change in solution viscosity may be determined by measuring the solution viscosity of the polyether block amide polymer before and after the aging process, and subtracting the “before” solution viscosity from the “after” solution viscosity. After the aging process, the solution viscosity of the polyether block amide polymer may be substantially unchanged (i.e., within 4% of the original solution viscosity).

In an example, the aged polyether block amide polymer (i.e., after the polyether block amide polymer has been heated to 125° C. for up to 125 hours) has a solution viscosity at 25° C. ranging from about 1.55 to about 1.80, based on American Society for Testing Materials (ASTM) standards using m-cresol as the solvent. In another example, the aged polyether block amide polymer (i.e., after the polyether block amide polymer has been heated to 125° C. for up to 125 hours) has a solution viscosity at 25° C. ranging from about 1.70 to about 1.80, based on American Society for Testing Materials (ASTM) standards using m-cresol as solvent. In still another example, aged polyether block amide polymer (i.e., after the polyether block amide polymer has been heated to 125° C. for up to 125 hours) has a solution viscosity at 25° C. of 1.75. In these examples, after the aging process, the polyether block amide polymer is cooled to 25° C. and the solution viscosity is measured at 25° C.

A polyether block amide polymer that is stable/non-reactive may be more suitable for being reused/recycled than less stable and/or more reactive polyether block amide polymers. As such, when the polyether block amide polymer is stable/non-reactive, the polyether block amide polymer may be reused/recycled. After a print cycle, some of the build material composition disclosed herein remains non-fused, and can be reclaimed and used again. This reclaimed build material is referred to as the recycled build material composition. The recycled build material composition may be exposed to 2, 4, 6, 8, 10, or more build cycles (i.e., heating to a temperature ranging from about 100° C. to about 130° C. and then cooling), and reclaimed after each cycle. Between cycles, the recycled build material composition may be mixed with at least some fresh or virgin (i.e., not previously used in a 3D printing process) build material composition. In some examples, the weight ratio of the recycled build material composition to the fresh build material composition may be 90:10, 80:20, 70:30, 60:40, 50:50, or 40:60. In another example, the recycled build material composition may be used without mixing it with any fresh build material composition (i.e., the recycled build material composition is 100% of the composition used). The weight ratio of the recycled build material composition to the fresh build material composition may depend, in part, on the stability of the build material composition, the discoloration of the recycled build material composition (as compared to the build material composition), the desired aesthetics for the 3D part being formed, and/or the desired mechanical properties of the 3D part being formed.

The powder or powder-like polyether block amide polymer disclosed herein may include similarly sized particles or differently sized particles. In some examples, the polyether block amide polymer is a ground material. In these examples, the polyether block amide polymer may have a wide particle size distribution. For example, the polyether block amide polymer may have a D90 value (i.e., 90% by volume of the population is below this value) that is greater than the D10 value (i.e., 10% by volume of the population is below this value) by 100 μm or more. As another example, the polyether block amide polymer may have a D90 value that is 5 or more times greater than the D10 value. For some build materials, a wide particle size distribution may prevent the patterned build material from sufficiently fusing/coalescing while maintaining the ability of the non-patterned build material to be broken apart after completion of the 3D part, as the smaller particles melt before the larger particles. However, it has been unexpectedly discovered that the particle size distribution of the polyether block amide polymer does not deleteriously affect the ability of the patterned polyether block amide polymer to sufficiently fuse/coalesce or the ability of the non-patterned polyether block amide polymer to be broken apart after completion of the 3D part.

The term “particle size”, as used herein, refers to the diameter of a spherical particle, or the average diameter of a non-spherical particle (i.e., the average of multiple diameters across the particle), or the volume-weighted mean diameter of a particle distribution. In some examples, the particle size may be determined using laser diffraction or laser scattering (e.g., with a Malvern Mastersizer S, version 2.18). In an example, the polyether block amide polymer has a particle size ranging from about 7 μm to about 225 μm. In another example, the polyether block amide polymer has an average particle size ranging from about 20 μm to about 130 μm. In still another example, the D50 value of the polyether block amide polymer (i.e., the median of the particle size distribution, where ½ the population is above this value and ½ is below this value) is about 70 μm. In still another example, the D10 value of the polyether block amide polymer is about 20 μm. In yet another example, the D90 value of the polyether block amide polymer is about 130 μm.

In some examples, the build material composition, in addition to the polyether block amide polymer, may include an antioxidant, a whitener, an antistatic agent, a flow aid, or a combination thereof. While several examples of these additives are provided, it is to be understood that these additives are selected to be thermally stable (i.e., will not decompose) at the 3D printing temperatures.

Antioxidant(s) may be added to the build material composition to prevent or slow molecular weight decreases of the polyether block amide polymer and/or may prevent or slow discoloration (e.g., yellowing) of the polyether block amide polymer by preventing or slowing oxidation of the polyether block amide polymer. In some examples, the antioxidant may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polyether block amide polymer. In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). In an example, any example of the whitener may be included in the build material composition in an amount ranging from greater than 0 wt % to about 10 wt %, based on the total weight of the build material composition.

Antistatic agent(s) may be added to the build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the build material composition.

Flow aid(s) may be added to improve the coating flowability of the build material composition. Flow aids may be particularly beneficial when the build material composition has an average particle size less than 25 μm. The flow aid improves the flowability of the build material composition by reducing the friction, the lateral drag, and the tribocharge buildup (by increasing the particle conductivity). Examples of suitable flow aids include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based upon the total weight of the build material composition.

3D Printing Kits and Compositions

The build material composition described herein may be part of a 3D printing kit. In an example, the 3D printing kit includes a build material composition including a polyether block amide polymer; and a fusing agent to be applied to at least a portion of the build material composition during 3D printing, the fusing agent including an energy absorber to absorb electromagnetic radiation to melt or fuse the at least the portion of the polyether block amide polymer. In another example, the 3D printing kit further comprises a detailing agent including a surfactant, a co-solvent, and water. The components of the kit may be maintained separately until used together in examples of the 3D printing method disclosed herein.

Also disclosed herein is a 3D printing composition. In an example, the three-dimensional (3D) printing composition comprises: a build material composition including a polyether block amide polymer; and a fusing agent including an energy absorber to absorb electromagnetic radiation to melt or fuse at least a portion of the polyether block amide polymer in areas exposed to the fusing agent. In another example, the 3D printing composition consists of the build material composition and the fusing agent with no other components. In still another example, the 3D printing composition includes additional components. In yet another example, the 3D printing composition further comprises a detailing agent including a surfactant, a co-solvent, and water.

As mentioned above, the build material composition includes at least the polyether block amide polymer, and may additionally include the antioxidant, the whitener, the antistatic agent, the flow aid, or combinations thereof. Any example of the build material composition may be used in the examples of the 3D printing kit or in the examples of the 3D printing composition.

The fusing agent includes at least the energy absorber. Any of the example compositions of the fusing agent described below may be used in the examples of the 3D printing kit or in the examples of the 3D printing composition.

The detailing agent may include the surfactant, the co-solvent, and water. Any of the example compositions of the detailing agent described below may be used in the examples of the 3D printing kit or in the examples of the 3D printing composition.

Fusing Agents

In the examples of the 3D printing composition, the 3D printing methods, and the 3D printing system disclosed herein a fusing agent may be used. Some examples of the fusing agent are dispersions including an energy absorber (i.e., an active material). In some examples, the active material may be any infrared light absorbing colorant. In an example, the active material is a near-infrared light absorber. Any near-infrared colorants, e.g., those produced by Fabricolor, Eastman Kodak, or BASF, Yamamoto, may be used in the fusing agent. As one example, the fusing agent may be a printing liquid formulation including carbon black as the active material. Examples of this printing liquid formulation are commercially known as CM997A, 516458, C18928, C93848, C93808, or the like, all of which are available from HP Inc.

Other suitable active materials include near-infrared absorbing dyes or plasmonic resonance absorbers.

As another example, the fusing agent may be a printing liquid formulation including near-infrared absorbing dyes as the active material. Examples of this printing liquid formulation are described in U.S. Pat. No. 9,133,344, incorporated herein by reference in its entirety. Some examples of the near-infrared absorbing dye are water-soluble near-infrared absorbing dyes selected from the group consisting of:

[chemical structure]

[chemical structure]

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

[chemical structure]

and mixtures thereof. For the hydrophobic near-infrared absorbing dyes, M can be a divalent metal atom (e.g., copper, etc.) or can include a metal that has Cl, Br, or OR′ (R′═H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used. Some examples include anthroquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthroquinone dyes or pigments and metal (e.g., nickel) dithiolene dyes or pigments may have the following structures, respectively:

[chemical structure]

where R in the anthroquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

[chemical structure]

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

[chemical structure]

Boron-dipyrromethene dyes or pigments and aza-boron-dipyrromethene dyes or pigments may have the following structures, respectively:

[chemical structure]

In other examples, the active material may be a plasmonic resonance absorber. The plasmonic resonance absorber allows the fusing agent to absorb radiation at wavelengths ranging from 800 nm to 4000 nm (e.g., at least 80% of radiation having wavelengths ranging from 800 nm to 4000 nm is absorbed), which enables the fusing agent to convert enough radiation to thermal energy so that the build material composition fuses/coalesces. The plasmonic resonance absorber also allows the fusing agent to have transparency at wavelengths ranging from 400 nm to 780 nm (e.g., 25% or less of radiation having wavelengths ranging from 400 nm to 780 nm is absorbed), which enables the 3D part to be white or slightly colored.

The absorption of the plasmonic resonance absorber is the result of the plasmonic resonance effects. Electrons associated with the atoms of the plasmonic resonance absorber may be collectively excited by radiation, which results in collective oscillation of the electrons. The wavelengths that can excite and oscillate these electrons collectively are dependent on the number of electrons present in the plasmonic resonance absorber particles, which in turn is dependent on the size of the plasmonic resonance absorber particles. The amount of energy that can collectively oscillate the particle's electrons is low enough that very small particles (e.g., 1-100 nm) may absorb radiation with wavelengths several times (e.g., from 8 to 800 or more times) the size of the particles. The use of these particles allows the fusing agent to be inkjet jettable as well as electromagnetically selective (e.g., having absorption at wavelengths ranging from 800 nm to 4000 nm and transparency at wavelengths ranging from 400 nm to 780 nm).

In an example, the plasmonic resonance absorber has an average particle diameter (e.g., volume-weighted mean diameter) ranging from greater than 0 nm to less than 220 nm. In another example the plasmonic resonance absorber has an average particle diameter ranging from greater than 0 nm to 120 nm. In a still another example, the plasmonic resonance absorber has an average particle diameter ranging from about 10 nm to about 200 nm.

In an example, the plasmonic resonance absorber is an inorganic pigment. Examples of suitable inorganic pigments include lanthanum hexaboride (LaB₆), tungsten bronzes (AₓWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), silver (Ag), gold (Au), platinum (Pt), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

The amount of the active material that is present in the fusing agent ranges from greater than 0 wt % to about 40 wt % based on the total weight of the fusing agent. In other examples, the amount of the active material in the fusing agent ranges from about 0.3 wt % to 30 wt %, from about 1 wt % to about 20 wt %, from about 1.0 wt % up to about 10.0 wt %, or from greater than 4.0 wt % up to about 15.0 wt %. It is believed that these active material loadings provide a balance between the fusing agent having jetting reliability and heat and/or radiation absorbance efficiency.

As used herein, “FA vehicle” may refer to the liquid in which the active material is dispersed or dissolved to form the fusing agent. A wide variety of FA vehicles, including aqueous and non-aqueous vehicles, may be used in the fusing agent. In some examples, the FA vehicle may include water alone or a non-aqueous solvent alone with no other components. In other examples, the FA vehicle may include other components, depending, in part, upon the first applicator that is to be used to dispense the fusing agent. Examples of other suitable fusing agent components include dispersant(s), silane coupling agent(s), co-solvent(s), surfactant(s), antimicrobial agent(s), anti-kogation agent(s), and/or chelating agent(s).

When the active material is the plasmonic resonance absorber, the plasmonic resonance absorber may, in some instances, be dispersed with a dispersant. As such, the dispersant helps to uniformly distribute the plasmonic resonance absorber throughout the fusing agent. Examples of suitable dispersants include polymer or small molecule dispersants, charged groups attached to the plasmonic resonance absorber surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL® 671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the fusing agent may range from about 10 wt % to about 200 wt % based on the weight of the plasmonic resonance absorber in the fusing agent.

When the active material is the plasmonic resonance absorber, a silane coupling agent may also be added to the fusing agent to help bond the organic and inorganic materials. Examples of suitable silane coupling agents include the SILQUEST® A series manufactured by Momentive.

Whether a single silane coupling agent is used or a combination of silane coupling agents is used, the total amount of silane coupling agent(s) in the fusing agent may range from about 0.1 wt % to about 50 wt % based on the weight of the plasmonic resonance absorber in the fusing agent. In an example, the total amount of silane coupling agent(s) in the fusing agent ranges from about 1 wt % to about 30 wt % based on the weight of the plasmonic resonance absorber. In another example, the total amount of silane coupling agent(s) in the fusing agent ranges from about 2.5 wt % to about 25 wt % based on the weight of the plasmonic resonance absorber.

The solvent of the fusing agent may be water or a non-aqueous solvent (e.g., ethanol, acetone, n-methyl pyrrolidone, aliphatic hydrocarbons, etc.). In some examples, the fusing agent consists of the active material and the solvent (without other components). In these examples, the solvent makes up the balance of the fusing agent.

Classes of organic co-solvents that may be used in a water-based fusing agent include aliphatic alcohols, aromatic alcohols, diols, glycol ethers, polyglycol ethers, 2-pyrrolidones, caprolactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, both substituted and unsubstituted formamides, both substituted and unsubstituted acetamides, and the like. Other examples of organic co-solvents include dimethyl sulfoxide (DMSO), isopropyl alcohol, ethanol, pentanol, acetone, or the like.

Other examples of suitable co-solvents include water-soluble high-boiling point solvents, which have a boiling point of at least 120° C., or higher. Some examples of high-boiling point solvents include 2-pyrrolidone (i.e., 2-pyrrolidinone, boiling point of about 245° C.), 1-methyl-2-pyrrolidone (boiling point of about 203° C.), N-(2-hydroxyethyl)-2-pyrrolidone (boiling point of about 140° C.), 2-methyl-1,3-propanediol (boiling point of about 212° C.), and combinations thereof.

The co-solvent(s) may be present in the fusing agent in a total amount ranging from about 1 wt % to about 50 wt % based upon the total weight of the fusing agent, depending upon the jetting architecture of the first applicator. In an example, the total amount of the co-solvent(s) present in the fusing agent is 25 wt % based on the total weight of the fusing agent.

The co-solvent(s) of the fusing agent may depend, in part, upon the jetting technology that is to be used to dispense the fusing agent. For example, if thermal inkjet printheads are to be used, water and/or ethanol and/or other longer chain alcohols (e.g., pentanol) may be the solvent (i.e., makes up 35 wt % or more of the fusing agent) or co-solvents. For another example, if piezoelectric inkjet printheads are to be used, water may make up from about 25 wt % to about 30 wt % of the fusing agent, and the solvent (i.e., 35 wt % or more of the fusing agent) may be ethanol, isopropanol, acetone, etc. The co-solvent(s) of the fusing agent may also depend, in part, upon the build material composition that is being used with the fusing agent. For a hydrophobic powder (e.g., a polyether block amide polymer including more polyamide blocks than polyether blocks, a polyether block amide polymer where the polyamide blocks are larger than the polyether blocks, a polyether block amide polymer where the polyether blocks are relatively hydrophobic, etc.), the FA vehicle may include a higher solvent content in order to improve the flow of the fusing agent into the build material composition.

The FA vehicle may also include humectant(s). In an example, the total amount of the humectant(s) present in the fusing agent ranges from about 3 wt % to about 10 wt %, based on the total weight of the fusing agent. An example of a suitable humectant is LIPONIC® EG-1 (i.e., LEG-1, glycereth-26, ethoxylated glycerol, available from Lipo Chemicals).

In some examples, the FA vehicle includes surfactant(s) to improve the jettability of the fusing agent. Examples of suitable surfactants include a self-emulsifiable, non-ionic wetting agent based on acetylenic diol chemistry (e.g., SURFYNOL® SEF from Air Products and Chemicals, Inc.), a non-ionic fluorosurfactant (e.g., CAPSTONE® fluorosurfactants, such as CAPSTONE® FS-35, from DuPont, previously known as ZONYL FSO), and combinations thereof. In other examples, the surfactant is an ethoxylated low-foam wetting agent (e.g., SURFYNOL® 440 or SURFYNOL® CT-111 from Air Products and Chemical Inc.) or an ethoxylated wetting agent and molecular defoamer (e.g., SURFYNOL® 420 from Air Products and Chemical Inc.). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TECO® Wet 510 (polyether siloxane) available from Evonik Industries).

Whether a single surfactant is used or a combination of surfactants is used, the total amount of surfactant(s) in the fusing agent may range from about 0.01 wt % to about 10 wt % based on the total weight of the fusing agent. In an example, the total amount of surfactant(s) in the fusing agent may be about 3 wt % based on the total weight of the fusing agent.

An anti-kogation agent may be included in the fusing agent that is to be jetted using thermal inkjet printing. Kogation refers to the deposit of dried printing liquid (e.g., fusing agent) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ O3A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol).

Whether a single anti-kogation agent is used or a combination of anti-kogation agents is used, the total amount of anti-kogation agent(s) in the fusing agent may range from greater than 0.20 wt % to about 0.65 wt % based on the total weight of the fusing agent. In an example, the oleth-3-phosphate is included in an amount ranging from about 0.20 wt % to about 0.60 wt %, and the low molecular weight polyacrylic acid polymer is included in an amount ranging from about 0.005 wt % to about 0.03 wt %.

The FA vehicle may also include antimicrobial agent(s). Suitable antimicrobial agents include biocides and fungicides. Example antimicrobial agents may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.).

In an example, the fusing agent may include a total amount of antimicrobial agents that ranges from about 0.05 wt % to about 1 wt %. In an example, the antimicrobial agent(s) is/are a biocide(s) and is/are present in the fusing agent in an amount of about 0.25 wt % (based on the total weight of the fusing agent).

Chelating agents (or sequestering agents) may be included in the FA vehicle to eliminate the deleterious effects of heavy metal impurities. Examples of chelating agents include disodium ethylenediaminetetraacetic acid (EDTA-Na), ethylene diamine tetra acetic acid (EDTA), and methylglycinediacetic acid (e.g., TRILON® M from BASF Corp.).

Whether a single chelating agent is used or a combination of chelating agents is used, the total amount of chelating agent(s) in the fusing agent may range from greater than 0 wt % to about 2 wt % based on the total weight of the fusing agent. In an example, the chelating agent(s) is/are present in the fusing agent in an amount of about 0.04 wt % (based on the total weight of the fusing agent).

Printing Methods

Referring now to FIGS. 1, 2, and 3A through 3E, examples of methods 100, 200, 300 for 3D printing are depicted. Prior to execution of any of the methods 100, 200, 300 disclosed herein or as part of the methods 100, 200, 300 a controller 30 (see, e.g., FIG. 4) may access data stored in a data store 32 (see, e.g., FIG. 4) pertaining to a 3D part that is to be printed. The controller 30 may determine the number of layers of the build material composition 16 that are to be formed and the locations at which the fusing agent 26 from the first applicator 24A is to be deposited on each of the respective layers.

As shown in FIG. 1, the method 100 for three-dimensional (3D) printing comprises: applying a build material composition 16 to form a build material layer 38, the build material composition 16 including a polyether block amide polymer (reference numeral 102); based on a 3D object model, selectively applying a fusing agent 26 on at least a portion 40 of the build material composition 16 (reference numeral 104); and exposing the build material composition 16 to radiation 44 to fuse the at least the portion 40 to form a layer 46 of a 3D part (reference numeral 106).

As shown in FIG. 2, the method 200 for three-dimensional (3D) printing comprises: applying a build material composition 16 to form a build material layer 38, the build material composition 16 including a polyether block amide polymer (reference numeral 202); based on a 3D object model, selectively applying a fusing agent 26 on a portion 40 of the build material composition 16 (reference numeral 204); based on the 3D object model, selectively applying a detailing agent 48 on another portion 42 of the build material composition 16 (reference numeral 206); and exposing the build material composition 16 to radiation 44 to fuse the portion 40 to form a layer 46 of a 3D part (reference numeral 208).

As shown at reference numeral 102 in FIG. 1, at reference numeral 202 in FIG. 2, and in FIGS. 3A and 3B, the methods 100, 200, 300 include applying the build material composition 16 to form the build material layer 38. As mentioned above, the build material composition 16 includes at least the polyether block amide polymer, and may additionally include the antioxidant, the whitener, the antistatic agent, the flow aid, or combinations thereof.

In the example shown in FIGS. 3A and 3B, a printing system (e.g., the printing system 10 shown in FIG. 4) may be used to apply the build material composition 16. The printing system 10 may include a build area platform 12, a build material supply 14 containing the build material composition 16, and a build material distributor 18.

The build area platform 12 receives the build material composition 16 from the build material supply 14. The build area platform 12 may be moved in the directions as denoted by the arrow 20, e.g., along the z-axis, so that the build material composition 16 may be delivered to the build area platform 12 or to a previously formed layer 46 (see FIG. 3E). In an example, when the build material composition 16 is to be delivered, the build area platform 12 may be programmed to advance (e.g., downward) enough so that the build material distributor 18 can push the build material composition 16 onto the build area platform 12 to form a substantially uniform layer 38 of the build material composition 16 thereon. The build area platform 12 may also be returned to its original position, for example, when a new part is to be built.

The build material supply 14 may be a container, bed, or other surface that is to position the build material composition 16 between the build material distributor 18 and the build area platform 12. In some examples, the methods 100, 200, 300 further include heating the build material composition 16 in the build material supply 14 to a supply temperature ranging from about 60° C. to about 80° C. In these examples, the heating of the build material composition 16 in the build material supply 14 may be accomplished by heating the build material supply 14 to the supply temperature.

The build material distributor 18 may be moved in the directions as denoted by the arrow 22, e.g., along the y-axis, over the build material supply 14 and across the build area platform 12 to spread the layer 38 of the build material composition 16 over the build area platform 12. The build material distributor 18 may also be returned to a position adjacent to the build material supply 14 following the spreading of the build material composition 16. The build material distributor 18 may be a blade (e.g., a doctor blade), a roller, a combination of a roller and a blade, and/or any other device capable of spreading the build material composition 16 over the build area platform 12. For instance, the build material distributor 18 may be a counter-rotating roller. In some examples, the build material supply 14 or a portion of the build material supply 14 may translate along with the build material distributor 18 such that build material composition 16 is delivered continuously to the material distributor 18 rather than being supplied from a single location at the side of the printing system 10 as depicted in FIG. 3A.

As shown in FIG. 3A, the build material supply 14 may supply the build material composition 16 into a position so that it is ready to be spread onto the build area platform 12. The build material distributor 18 may spread the supplied build material composition 16 onto the build area platform 12. The controller 30 may process control build material supply data, and in response, control the build material supply 14 to appropriately position the particles of the build material composition 16, and may process control spreader data, and in response, control the build material distributor 18 to spread the supplied build material composition 16 over the build area platform 12 to form the layer 38 of build material composition 16 thereon. As shown in FIG. 3B, one build material layer 38 has been formed.

The layer 38 of the build material composition 16 has a substantially uniform thickness across the build area platform 12. In an example, the build material layer 38 has a thickness ranging from about 70 μm to about 100 μm. In another example, the thickness of the build material layer 38 is about 80 μm. It is to be understood that thinner or thicker layers may also be used. For example, the thickness of the build material layer 38 may range from about 20 μm to about 500 μm. The layer thickness may be about 2× (i.e., 2 times) the average polyether block amide polymer diameter (as shown in FIG. 3B) at a minimum for finer part definition. In some examples, the layer thickness may be about 1.2× the average polyether block amide polymer diameter.

After the build material composition 16 has been applied, and prior to further processing, the build material layer 38 may be exposed to heating. Heating may be performed to pre-heat the build material composition 16, and thus the heating temperature may be below the melting range of the polyether block amide polymer. As such, the temperature selected will depend upon the build material composition 16 that is used. As examples, the pre-heating temperature may be from about 5° C. to about 50° C. below the lowest temperature in the melting range of the polyether block amide polymer. In an example, the pre-heating temperature ranges from about 50° C. to about 130° C. In another example, the pre-heating temperature ranges from about 100° C. to about 130° C. In still another example, the methods 100, 200, 300 further comprise, prior to the selectively applying of the fusing agent 26, pre-heating the build material composition to a pre-heating temperature ranging from about 110° C. to about 125° C. The low pre-heating temperature may enable the non-patterned build material composition 16 (e.g., in the other portion(s) 42) to be easily removed from the 3D part after completion of the 3D part.

Pre-heating the layer 38 of the build material composition 16 may be accomplished by using any suitable heat source that exposes all of the build material composition 16 on the build area platform 12 to the heat. Examples of the heat source include a thermal heat source (e.g., a heater (not shown) integrated into the build area platform 12 (which may include sidewalls)) or the radiation source 34, 34′ (see, e.g., FIG. 4).

As shown at reference numeral 104 in FIG. 1, at reference numeral 204 in FIG. 2, and in FIG. 3C, the methods 100, 200, 300 continue by selectively applying, based on a 3D object model, the fusing agent 26 on at least a portion 40 of the build material composition 16. The fusing agent 26 includes at least the energy absorber. Example compositions of the fusing agent 26 are described above.

It is to be understood that a single fusing agent 26 may be selectively applied on the portion 40, or multiple fusing agents 26 may be selectively applied on the portion 40. As an example, multiple fusing agents 26 may be used to create a multi-colored part. As another example, one fusing agent 26 may be applied to an interior portion of a layer and/or to interior layer(s) of a 3D part, and a second fusing agent 26 may be applied to the exterior portion(s) of the layer and/or to the exterior layer(s) of the 3D part. In the latter example, the color of the second fusing agent 26 will be exhibited at the exterior of the part.

It is also to be understood that the selective application of the fusing agent 26 may be accomplished in a single printing pass or in multiple printing passes. In an example, selectively applying of the fusing agent 26 is accomplished in multiple printing passes. In another example, selectively applying of the fusing agent 26 is accomplished in a number of printing passes ranging from 2 to 4. In still another example, selectively applying of the fusing agent 26 is accomplished in 2 printing passes. In yet another example, selectively applying of the fusing agent 26 is accomplished in 4 printing passes. It may be desirable to apply the fusing agent 26 in multiple printing passes to increase the amount of the energy absorber that is applied to the build material layer 38, to avoid liquid splashing, to avoid displacement of the build material composition 16, etc.

The volume of the fusing agent 26 that is applied per unit of the build material composition 16 in the patterned portion 40 may be sufficient to absorb and convert enough radiation 44 so that the build material composition 16 in the patterned portion 40 will fuse/coalesce. The volume of the fusing agent 26 that is applied per unit of the build material composition 16 may depend, at least in part, on the energy absorber used, the energy absorber loading in the fusing agent 26, and the build material composition 16 used.

As illustrated in FIG. 3C, the fusing agent 26 may be dispensed from the first applicator 24A. The first applicator 24A may be a thermal inkjet printhead, a piezoelectric printhead, a continuous inkjet printhead, etc., and the selective application of the fusing agent 26 may be accomplished by thermal inkjet printing, piezo electric inkjet printing, continuous inkjet printing, etc.

The controller 30 may process data, and in response, control the first applicator 24A (e.g., in the directions indicated by the arrow 28) to deposit the fusing agent 26 onto predetermined portion(s) 40 of the build material layer 38 that are to become part of the 3D part. The first applicator 24A may be programmed to receive commands from the controller 30 and to deposit the fusing agent 26 according to a pattern of a cross-section for the layer of the 3D part that is to be formed. As used herein, the cross-section of the layer of the 3D part to be formed refers to the cross-section that is parallel to the surface of the build area platform 12. In the example shown in FIG. 3C, the first applicator 24A selectively applies the fusing agent 26 on those portion(s) 40 of the build material layer 38 that is/are to become the first layer of the 3D part. As an example, if the 3D part that is to be formed is to be shaped like a cube or cylinder, the fusing agent 26 will be deposited in a square pattern or a circular pattern (from a top view), respectively, on at least a portion of the build material layer 38. In the example shown in FIG. 3C, the fusing agent 26 is deposited on the portion 40 of the build material layer 38 and not on the portions 42.

As shown at reference numeral 106 in FIG. 1, at reference numeral 208 in FIG. 2, and in FIGS. 3C and 3D, the methods 100, 200, 300 may continue by exposing the build material composition 16 to radiation 44 to fuse/coalesce the at least the portion 40 to form a layer 46 of a 3D part. The radiation 44 may be applied with the source 34 of radiation 44 as shown in FIG. 3D or with the source 34′ of radiation 44 as shown in FIG. 3C.

It is to be understood that the exposing of the build material composition 16 to radiation 44 may be accomplished in a single radiation event or in multiple radiation events. In an example, the exposing of the build material composition 16 is accomplished in multiple radiation events. In another example, the exposing of the build material composition 16 to radiation 44 may be accomplished in a number of radiation events ranging from 3 to 8. In still another example, the exposing of the build material composition 16 to radiation 44 may be accomplished in 3 radiation events. It may be desirable to expose the build material composition 16 to radiation 44 in multiple radiation events to counteract a cooling effect that may be brought on by the amount of the fusing agent 26 that is applied to the build material layer 38. Additionally, it may be desirable to expose the build material composition 16 to radiation 44 in multiple radiation events to sufficiently elevate the temperature of the build material composition 16 in the portion(s) 40, without over heating the build material composition 16 in the portion(s) 42.

The fusing agent 26 enhances the absorption of the radiation 44, converts the absorbed radiation 44 to thermal energy, and promotes the transfer of the thermal heat to the build material composition 16 in contact therewith. In an example, the fusing agent 26 sufficiently elevates the temperature of the build material composition 16 in the layer 38 to within or above the melting of the polyether block amide polymer, allowing fusing/coalescing (e.g., thermal merging, melting, binding, etc.) of the build material composition 16 to take place. The application of the radiation 44 forms the fused layer 46, shown in FIG. 3D.

It is to be understood that portions 42 of the build material layer 38 that do not have the fusing agent 26 applied thereto do not absorb enough radiation 44 to fuse/coalesce. As such, these portions 42 do not become part of the 3D part that is ultimately formed. The build material composition 16 in portions 42 may be reclaimed to be reused as build material in the printing of another 3D part.

In some examples of the methods 100, 200, 300, the radiation 44 has a wavelength ranging from 400 nm to 1400 nm. In another example the radiation 44 has a wavelength ranging from 800 nm to 1400 nm. In still another example, radiation has a wavelength ranging from 400 nm to 1200 nm. Radiation 44 having wavelengths within the provided ranges may be absorbed (e.g., 80% or more of the applied radiation 44 is absorbed) by the fusing agent 26 and may heat the build material composition 16 in contact therewith, and may not be substantially absorbed (e.g., 25% or less of the applied radiation 44 is absorbed) by the non-patterned build material composition 16.

In some examples, the methods 100, 200, 300 further comprise repeating the applying of the build material composition 16, the selectively applying of the fusing agent 26, and the exposing of the build material composition 16, wherein the repeating forms the 3D part including the layer 46. In these examples, the processes shown in FIGS. 1, 2, and 3A through 3D may be repeated to iteratively build up several fused layers and to form the 3D printed part.

FIG. 3E illustrates the initial formation of a second build material layer on the previously formed layer 46. In FIG. 3E, following the fusing/coalescing of the predetermined portion(s) 40 of the build material composition 16, the controller 30 may process data, and in response, cause the build area platform 12 to be moved a relatively small distance in the direction denoted by the arrow 20. In other words, the build area platform 12 may be lowered to enable the next build material layer to be formed. For example, the build material platform 12 may be lowered a distance that is equivalent to the height of the build material layer 38. In addition, following the lowering of the build area platform 12, the controller 30 may control the build material supply 14 to supply additional build material composition 16 (e.g., through operation of an elevator, an auger, or the like) and the build material distributor 18 to form another build material layer on top of the previously formed layer 46 with the additional build material composition 16. The newly formed build material layer may be in some instances pre-heated, patterned with the fusing agent 26, and then exposed to radiation 44 from the source 34, 34′ of radiation 44 to form the additional fused layer.

Several variations of the previously described methods 100, 200, 300 will now be described.

In some examples of the methods 100, 200, 300, a detailing agent 48 may be used (see FIG. 3C). Example compositions of the detailing agent 48 are described below. The detailing agent 48 may be dispensed from another (e.g., a second) applicator 24B (which may be similar to applicator 24A) and applied to portion(s) of the build material composition 16.

The detailing agent 48 may provide an evaporative cooling effect to the build material composition 16 to which it is applied. The cooling effect of the detailing agent 48 reduces the temperature of the build material composition 16 containing the detailing agent 48 during energy/radiation exposure. The detailing agent 48, and its rapid cooling effect, may be used to obtain different levels of melting/fusing/binding within the layer 46 of the 3D part that is being formed. Different levels of melting/fusing/binding may be desirable to control internal stress distribution, warpage, mechanical strength performance, and/or elongation performance of the final 3D part.

In an example of using the detailing agent 48 to obtain different levels of melting/fusing/binding within the layer 46, the fusing agent 26 may be selectively applied according to the pattern of the cross-section for the layer 46 of the 3D part, and the detailing agent 48 may be selectively applied on at least some of that cross-section. As such, some examples of the methods 100, 200, 300 further comprise selectively applying, based on the 3D object model, the detailing agent 48 on the at least some of the at least the portion 40 of the build material composition 16. The evaporative cooling provided by the detailing agent 48 may remove energy from the at least some of the portion 40; however, since the fusing agent 26 is present with the detailing agent 48, fusing is not completely prevented. The level of fusing may be altered due to the evaporative cooling, which may alter the internal stress distribution, warpage, mechanical strength performance, and/or elongation performance of the 3D part. It is to be understood that when the detailing agent 48 is applied within the same portion 40 as the fusing agent 26, the detailing agent 48 may be applied in any desirable pattern. The detailing agent 48 may be applied before, after, or at least substantially simultaneously (e.g., one immediately after the other in a single printing pass, or at the same time) with the fusing agent 26, and then the build material composition 16 is exposed to radiation.

In some examples, the detailing agent 48 may also or alternatively be applied after the layer 46 is fused to control thermal gradients within the layer 46 and/or the final 3D part. In these examples, the thermal gradients may be controlled with the evaporative cooling provided by the detailing agent 48.

In another example that utilizes the evaporative cooling effect of the detailing agent 48, the methods 100, 200, 300 further comprise selectively applying the detailing agent 48 on another portion 42 of the build material composition 16 to aid in preventing the build material composition 16 in the other portion 42 from fusing. An example of this is shown in FIG. 2, at reference numeral 206, and in FIG. 3C. While the example shown in FIG. 3C shows the detailing agent 48 being applied on the other portion 42, the detailing agent 48 is not actually shown among the build material composition 16 in the other portion 42. It is to be understood that when the detailing agent 48 is applied on the other portion 42, the detailing agent 48 may remain in the other portion 42 until the detailing agent 48 evaporates from the build material layer 38.

In these examples, the detailing agent 48 is selectively applied, based on the 3D object model, on the other portion(s) 42 of the build material composition 16. The evaporative cooling provided by the detailing agent 48 may remove energy from the other portion 42, which may lower the temperature of the build material composition 16 in the other portion 42 and prevent the build material composition 16 in the other portion 42 from fusing/coalescing. The lower temperature of the build material composition 16 (due to the evaporative cooling provided by the detailing agent 48) may also improve the ability of the build material composition 16 in the other portion 42 to be removed after completion of the 3D part.

In some examples, the methods 100, 200, 300 may be accomplished in an air environment. As used herein, an “air environment” or an “environment containing air” refers to an environment that contains 20 vol % or more of oxygen.

In some examples of the methods 100, 200, 300, the polyether block amide polymer (included in the build material composition 16) has a solution viscosity at 25° C. ranging from about 1.70 to about 1.80. In these examples, the 3D parts formed by the methods 100, 200, 300 may have improved interlayer adhesion strength, as compared to the interlayer adhesion strength of 3D parts formed with build material including a polyether block amide polymer that has a solution viscosity at 25° C. that is lower than 1.70, or that is higher than the peak solution viscosity. This improved interlayer adhesion strength of the 3D parts may result in increased ultimate tensile strength, elongation at break, and/or tear strength of the 3D parts.

In an example, the 3D parts formed by the methods 100, 200, 300 may have an ultimate tensile strength that is increased by 35% or more. In another example, the 3D parts formed by the methods 100, 200, 300 may have an ultimate tensile strength greater than or equal to 10 MPa. In still another example, the 3D parts formed by the methods 100, 200, 300 may have an ultimate tensile strength of about 12.1 MPa. In these examples, the ultimate tensile strength may be measured according to Deutsches Institut fur Normung E.V. (DIN) standards (53504).

In an example, the 3D parts formed by the methods 100, 200, 300 may have an elongation at break that is increased by 75% or more. In another example, the 3D parts formed by the methods 100, 200, 300 may have an elongation at break greater than or equal to 500%. In still another example, the 3D parts formed by the methods 100, 200, 300 may have an elongation at break of about 550%. In these examples, the elongation at break may be measured according to Deutsches Institut fur Normung E.V. (DIN) standards (53504). As used herein, “elongation at break” (also known as strain at break) refers to the change in gauge length of the 3D part, when it breaks, as a percentage of the original gauge length. For example, a 3D part with an original length of 10 cm and an elongation at break of 20%, would have a length of 12 cm at its break.

In an example, the 3D parts formed by the methods 100, 200, 300 may have a tear strength greater than or equal to 60 kN/m. In another example, the 3D parts formed by the methods 100, 200, 300 may have a tear strength of about 65 kN/m. In these examples, the tear strength may be measured according to American Society for Testing Materials (ASTM) standards (D624 Die C).

Printing System

Referring now to FIG. 4, an example of a 3D printing system 10 is schematically depicted. It is to be understood that the 3D printing system 10 may include additional components (some of which are described herein) and that some of the components described herein may be removed and/or modified. Furthermore, components of the 3D printing system 10 depicted in FIG. 4 may not be drawn to scale and thus, the 3D printing system 10 may have a different size and/or configuration other than as shown therein.

In an example, the three-dimensional (3D) printing system 10, comprises: a supply 14 of a build material composition 16 including a polyether block amide polymer; a build material distributor 18; a supply of a fusing agent 26; a first applicator 24A for selectively dispensing the fusing agent 26; a source 34, 34′ of radiation 44; a controller 30; and a non-transitory computer readable medium having stored thereon computer executable instructions to cause the controller 30 to: utilize the build material distributor 18 to dispense the build material composition 16; utilize the first applicator 24A to selectively dispense the fusing agent 26 on at least a portion 40 of the build material composition 16; and utilize the source 34, 34′ of radiation 44 to expose the build material composition 16 to radiation 44 to fuse/coalesce the at least the portion 40 of the build material composition 16. Any example of the build material composition 16 may be used in the examples of the system 10.

In some examples, the 3D printing system 10 may further include a supply of a detailing agent 48; and a second applicator 24B for selectively dispensing the detailing agent 48. In these examples, the computer executable instructions may further cause the controller 30 to utilize the second applicator 24B to selectively dispense the detailing agent 48.

As shown in FIG. 4, the printing system 10 includes the build area platform 12, the build material supply 14 containing the build material composition 16 including the polyether block amide polymer, and the build material distributor 18.

As mentioned above, the build area platform 12 receives the build material composition 16 from the build material supply 14. The build area platform 12 may be integrated with the printing system 10 or may be a component that is separately insertable into the printing system 10. For example, the build area platform 12 may be a module that is available separately from the printing system 10. The build material platform 12 that is shown is one example, and could be replaced with another support member, such as a platen, a fabrication/print bed, a glass plate, or another build surface.

As also mentioned above, the build material supply 14 may be a container, bed, or other surface that is to position the build material composition 16 between the build material distributor 18 and the build area platform 12. In some examples, the build material supply 14 may include a surface upon which the build material composition 16 may be supplied, for instance, from a build material source (not shown) located above the build material supply 14. Examples of the build material source may include a hopper, an auger conveyer, or the like. Additionally, or alternatively, the build material supply 14 may include a mechanism (e.g., a delivery piston) to provide, e.g., move, the build material composition 16 from a storage location to a position to be spread onto the build area platform 12 or onto a previously formed layer 46 of the 3D part.

As also mentioned above, the build material distributor 18 may be a blade (e.g., a doctor blade), a roller, a combination of a roller and a blade, and/or any other device capable of spreading the build material composition 16 over the build area platform 12 (e.g., a counter-rotating roller).

As shown in FIG. 4, the printing system 10 includes the first applicator 24A, which may contain the fusing agent 26. As also shown, the printing system 10 may further include the second applicator 24B (which may contain the detailing agent 48).

The applicator(s) 24A, 24B may be scanned across the build area platform 12 in the directions indicated by the arrow 28, e.g., along the y-axis. The applicator(s) 24A, 24B may be, for instance, a thermal inkjet printhead, a piezoelectric printhead, a continuous inkjet printhead, etc., and may extend a width of the build area platform 12. While the each applicator 24A, 24B is shown in FIG. 4 as a single applicator, it is to be understood that each applicator 24A, 24B may include multiple applicators that span the width of the build area platform 12. Additionally, the applicators 24A, 24B may be positioned in multiple printbars. The applicator(s) 24A, 24B may also be scanned along the x-axis, for instance, in configurations in which the applicator(s) 24A, 24B do/does not span the width of the build area platform 12 to enable the applicator(s) 24A, 24B to deposit the respective agents 26, 48 over a large area of the build material composition 16. The applicator(s) 24A, 24B may thus be attached to a moving XY stage or a translational carriage (neither of which is shown) that moves the applicator(s) 24A, 24B adjacent to the build area platform 12 in order to deposit the respective agents 26, 48 in predetermined areas of the build material layer 38 that has been formed on the build area platform 12 in accordance with the methods 100, 200, 300 disclosed herein. The applicator(s) 24A, 24B may include a plurality of nozzles (not shown) through which the respective agents 26, 48 are to be ejected.

The applicator(s) 24A, 24B may deliver drops of the respective agents 26, 48 at a resolution ranging from about 300 dots per inch (DPI) to about 1200 DPI. In other examples, the applicator(s) 24A, 24B may deliver drops of the respective agents 26, 48 at a higher or lower resolution. The drop velocity may range from about 10 m/s to about 24 m/s and the firing frequency may range from about 1 kHz to about 48 kHz. In one example, the volume of each drop may be on the order of about 3 picoliters (pL) to about 18 pL, although it is contemplated that a higher or lower drop volume may be used. In some examples, the applicator(s) 24A, 24B is/are able to deliver variable drop volumes of the respective agents 26, 48. One example of a suitable printhead has 600 DPI resolution and can deliver drop volumes ranging from about 6 pL to about 14 pL.

Each of the previously described physical elements may be operatively connected to a controller 30 of the printing system 10. The controller 30 may process print data that is based on a 3D object model of the 3D object/part to be generated. In response to data processing, the controller 30 may control the operations of the build area platform 12, the build material supply 14, the build material distributor 18, and the applicator(s) 24A, 24B. As an example, the controller 30 may control actuators (not shown) to control various operations of the 3D printing system 10 components. The controller 30 may be a computing device, a semiconductor-based microprocessor, a central processing unit (CPU), an application specific integrated circuit (ASIC), and/or another hardware device. Although not shown, the controller 30 may be connected to the 3D printing system 10 components via communication lines.

The controller 30 manipulates and transforms data, which may be represented as physical (electronic) quantities within the printer's registers and memories, in order to control the physical elements to create the 3D part. As such, the controller 30 is depicted as being in communication with a data store 32. The data store 32 may include data pertaining to a 3D part to be printed by the 3D printing system 10. The data for the selective delivery of the build material composition 16, the fusing agent 26, etc. may be derived from a model of the 3D part to be formed. For instance, the data may include the locations on each build material layer 38 that the first applicator 24A is to deposit the fusing agent 26. In one example, the controller 30 may use the data to control the first applicator 24A to selectively apply the fusing agent 26. The data store 32 may also include machine readable instructions (stored on a non-transitory computer readable medium) that are to cause the controller 30 to control the amount of build material composition 16 that is supplied by the build material supply 14, the movement of the build area platform 12, the movement of the build material distributor 18, the movement of the applicator(s) 24A, 24B, etc.

As shown in FIG. 4, the printing system 10 may also include a source 34, 34′ of radiation 44. In some examples, the source 34 of radiation 44 may be in a fixed position with respect to the build material platform 12. The source 34 in the fixed position may be a conductive heater or a radiative heater that is part of the printing system 10. These types of heaters may be placed below the build area platform 12 (e.g., conductive heating from below the platform 12) or may be placed above the build area platform 12 (e.g., radiative heating of the build material layer surface). In other examples, the source 34′ of radiation 44 may be positioned to apply radiation 44 to the build material composition 16 immediately after the fusing agent 26 has been applied thereto. In the example shown in FIG. 4, the source 34′ of radiation 44 is attached to the side of the applicators 24A, 24B which allows for patterning and heating/exposing to radiation 44 in a single pass.

The source 34, 34′ of radiation 44 may emit radiation 44 having wavelengths ranging from about 400 nm to about 1400 nm. As one example, the radiation 44 may range from about 800 nm to about 1400 nm. As another example, the radiation 44 may range from about 400 nm to about 1200 nm. As still another example, the radiation 44 may be blackbody radiation with a maximum intensity at a wavelength of about 1100 nm. In some examples, the source 34, 34′ of radiation 44 may emit radiation 44 having wavelengths slightly higher than 1400 nm (e.g., 1500 nm). The source 34, 34′ of radiation 44 may be infrared (IR) or near-infrared light sources, such as IR or near-IR curing lamps, IR or near-IR light emitting diodes (LED), or lasers with the desirable IR or near-IR electromagnetic wavelengths.

The source 34, 34′ of radiation 44 may be operatively connected to a lamp/laser driver, an input/output temperature controller, and temperature sensors, which are collectively shown as radiation system components 36. The radiation system components 36 may operate together to control the source 34, 34′ of radiation 44. The temperature recipe (e.g., radiation exposure rate) may be submitted to the input/output temperature controller. During heating, the temperature sensors may sense the temperature of the build material composition 16, and the temperature measurements may be transmitted to the input/output temperature controller. For example, a thermometer associated with the heated area can provide temperature feedback. The input/output temperature controller may adjust the source 34, 34′ of radiation 44 power set points based on any difference between the recipe and the real-time measurements. These power set points are sent to the lamp/laser drivers, which transmit appropriate lamp/laser voltages to the source 34, 34′ of radiation 44. This is one example of the radiation system components 36, and it is to be understood that other radiation source control systems may be used. For example, the controller 30 may be configured to control the source 34, 34′ of radiation 44.

Detailing Agents

In the examples of the methods 100, 200, 300 and the system 10 disclosed herein, and as mentioned above, a detailing agent 48 may be used. The detailing agent 48 may include a surfactant, a co-solvent, and a balance of water. In some examples, the detailing agent 48 consists of these components, and no other components. In some other examples, the detailing agent 48 may further include a colorant. In still some other examples, detailing agent 48 consists of a colorant, a surfactant, a co-solvent, and a balance of water, with no other components. In yet some other examples, the detailing agent 48 may further include additional components, such as anti-kogation agent(s), antimicrobial agent(s), and/or chelating agent(s) (each of which is described above in reference to the fusing agent 26).

The surfactant(s) that may be used in the detailing agent 48 include any of the surfactants listed above in reference to the fusing agent 26. The total amount of surfactant(s) in the detailing agent 48 may range from about 0.10 wt % to about 5.00 wt % with respect to the total weight of the detailing agent 48.

The co-solvent(s) that may be used in the detailing agent 48 include any of the co-solvents listed above in reference to the fusing agent 26. The total amount of co-solvent(s) in the detailing agent 48 may range from about 1.00 wt % to about 20.00 wt % with respect to the total weight of the detailing agent 48.

Similar to the fusing agent 26, the co-solvent(s) of the detailing agent 48 may depend, in part upon the jetting technology that is to be used to dispense the detailing agent 48. For example, if thermal inkjet printheads are to be used, water and/or ethanol and/or other longer chain alcohols (e.g., pentanol) may make up 35 wt % or more of the detailing agent 48. For another example, if piezoelectric inkjet printheads are to be used, water may make up from about 25 wt % to about 30 wt % of the detailing agent 48, and 35 wt % or more of the detailing agent 48 may be ethanol, isopropanol, acetone, etc.

When the detailing agent 48 includes the colorant, the colorant may be a dye of any color that absorbs no radiation having wavelengths in a range of 650 nm to 2500 nm, or that absorbs less than 10% of radiation having wavelengths in a range of 650 nm to 2500 nm. The dye is also capable of absorbing radiation with wavelengths of 650 nm or less. As such, the dye absorbs at least some wavelengths within the visible spectrum, but absorbs little or no wavelengths within the near-infrared spectrum. This is in contrast to the active material in the fusing agent 26, which absorbs wavelengths within the near-infrared spectrum. As such, the colorant in the detailing agent 48 will not substantially absorb the fusing radiation, and thus will not initiate melting and fusing of the build material composition 16 in contact therewith when the build material layer 38 is exposed to the fusing radiation.

The dye selected as the colorant in the detailing agent 48 may also have a high diffusivity (i.e., it may penetrate into greater than 10 μm and up to 100 μm of the build material composition particles 16). The high diffusivity enables the dye to penetrate into the build material composition particles 16 upon which the detailing agent 48 is applied, and also enables the dye to spread into portions of the build material composition 16 that are adjacent to the portions of the build material composition 16 upon which the detailing agent 48 is applied. The dye penetrates deep into the build material composition 16 particles to dye/color the composition particles. When the detailing agent 48 is applied at or just outside the edge boundary (of the final 3D part), the build material composition 16 particles at the edge boundary may be colored. In some examples, at least some of these dyed build material composition 16 particles may be present at the edge(s) or surface(s) of the formed 3D layer or part, which prevents or reduces any patterns (due to the different colors of the fusing agent 26 and the build material composition 16) from forming at the edge(s) or surface(s).

The dye in the detailing agent 48 may be selected so that its color matches the color of the active material in the fusing agent 26. As examples, the dye may be any azo dye having sodium or potassium counter ion(s) or any diazo (i.e., double azo) dye having sodium or potassium counter ion(s), where the color of azo or dye azo dye matches the color of the fusing agent 26.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

[chemical structure]

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

[chemical structure]

(commercially available as Food Black 2); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

[chemical structure]

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

[chemical structure]

and combinations thereof. Some other commercially available examples of the dye used in the detailing agent 48 include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent 48 may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D part.

Some examples of the other dye include a salt, such as a sodium salt, an ammonium salt, or a potassium salt. Some specific examples include ethyl-[4-[[4-[ethyl-[(3-sulfophenyl) methyl] amino] phenyl]-(2-sulfophenyl) ethylidene]-1-cyclohexa-2,5-dienylidene]-[(3-sulfophenyl) methyl] azanium with a chemical structure of:

[chemical structure]

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl]benzene-1,3-disulfonate with a chemical structure of:

[chemical structure]

(commercially available as Acid Blue 7); and a phthalocyanine with a chemical structure of:

[chemical structure]

(commercially available as Direct Blue 199); and combinations thereof.

In an example of the detailing agent 48, the dye may be present in an amount ranging from about 1.00 wt % to about 3.00 wt % based on the total weight of the detailing agent 48. In another example of the detailing agent 48 including a combination of dyes, one dye (e.g., the black dye) is present in an amount ranging from about 1.50 wt % to about 1.75 wt % based on the total weight of the detailing agent 48, and the other dye (e.g., the cyan dye) is present in an amount ranging from about 0.25 wt % to about 0.50 wt % based on the total weight of the detailing agent 48.

The balance of the detailing agent 48 is water. As such, the amount of water may vary depending upon the amounts of the other components that are included.

To further illustrate the present disclosure, examples are given herein. It is to be understood these examples are provided for illustrative purposes and are not to be construed as limiting the scope of the present disclosure.

### EXAMPLES

### Example 1

An example of the build material composition disclosed herein (i.e., the first example build material composition), which included a polyether block amide polymer, was tested to determine its solution viscosity, particle size distribution, and avalanche angle.

The relative solution viscosity at 25° C. of the first example build material composition was determined to be about 1.55 using ASTM standards using m-cresol as the solvent.

The particle size distribution of the first example build material composition was measured using laser diffraction. The D10 value was determined to be about 21 μm; the D50 value was determined to be about 69 μm; and the D90 value was determined to be about 129 μm.

The avalanche angle at room temperature of the first example build material composition was determined to be about 60° using a REVOLUTION™ instrument (from Mercury Scientific Inc.) at a revolution rate of 0.6 rpm.

Several 3D parts were printed with the first example build material composition using several variations of the 3D printing methods disclosed herein. Each 3D part was printed on a small testbed 3D printer with an example fusing agent that included carbon black as the energy absorber. Each 3D part was also printed using a supply temperature ranging from about 60° C. to about 80° C. and a printbed temperature/pre-heating temperature ranging from about 100° C. to about 130° C. One 3D part was printed with about 80 μm thick build material layers, 2 printing passes to apply the example fusing agent to each build material layer, and 3 radiation events to expose each build material layer to radiation. Other 3D parts were printed with build material layers that had a thickness ranging from about 70 μm to about 100 μm, 4 printing passes to apply the example fusing agent to each build material layer, and/or the number of radiation events (during which each build material layer was exposed to radiation) ranging from 3 to 8.

Each of the 3D parts was sufficiently fused/coalesced. Further, the non-patterned build material adjacent to each of the 3D parts was able to be removed and separated from the completed 3D part. Thus, the first example build material composition was shown to be a suitable build material composition for the 3D printing methods disclosed herein.

### Example 2

Several XY dogbones were printed using the first example build material composition (from Example 1). Several XY dogbones were also printed using another example of the build material (i.e., the second example build material composition), which included a polyether block amide polymer.

The solution relative viscosity at 25° C. of the second example build material composition was determined to be about 1.7 using ASTM standards using m-cresol as the solvent. The avalanche angle at room temperature of the second example build material composition was determined to be about 54° using a REVOLUTION™ instrument (from Mercury Scientific Inc.) at a revolution rate of 0.6 rpm.

Each of the XY dogbones was printed on a large format 3D printer with the example fusing agent (from Example 1), and 1200 build material layers that were each about 80 μm thick.

The ultimate tensile strength and the elongation at break of all of the XY dogbones were measured using DIN standard 53504. The tensile strength at 10% strain, the tensile strength at 50% strain, and the tensile strength at 100% strain of the XY dogbones (S2 specimens) were measured. The tear strength of the XY dogbones was measured using ASTM standards D624 Die C. The compression set (22 hours at 70° C.) of the XY dogbones was measured using ASTM standard D395. The elastic rebound of the XY dogbones was measured using DIN standard 53512. The Shore D hardness of the XY dogbones was measured using ASTM standard D2240. The average value for each of these measurements is shown in Table 1. In Table 1, the XY dogbones are identified by the build material composition used to form the XY dogbones.

TABLE 1

| | First example | Second example |
|---|---|---|
| | build material | build material |
| | composition | composition |
| Ultimate tensile strength | 8.8 | 12.1 |
| (MPa) | | |
| Elongation at break (%) | 310 | 550 |
| Tensile strength at 10% | 4.4 | 4.2 |
| strain (MPa) | | |
| Tensile strength at 50% | 7.0 | 6.7 |
| strain (MPa) | | |
| Tensile strength at 100% | 7.5 | 7.4 |
| strain (MPa) | | |
| Tear strength (kN/m) | 50 | 65 |
| Compression set (%) | 76 | — |
| Elastic rebound (%) | 64.5 | 69.9 |
| Hardness | 33 | 33 |

As shown in Table 1, the ultimate tensile strength, the elongation at break, and the tear strength of the XY dogbones formed from the second example build material composition were greater than the ultimate tensile strength, the elongation at break, and the tear strength of the XY dogbones formed from the first example build material composition. This indicates that the ultimate tensile strength, the elongation at break, and the tear strength were improved when the polyether block amide polymer with the higher solution viscosity was used.

### Example 3

The stability/non-reactivity of the first example build material composition (from Example 1) was also tested. The first example build material composition was aged at 125° C. in an air environment. The relative solution viscosity at 25° C. of the first example build material composition was measured before the aging process (i.e., 0 hours aged) and at several points during the aging process (i.e., 12.5 hours aged, 25 hours aged, 37.5 hours aged, 50 hours aged, 62.5 hours aged, 75 hours aged, 87.5 hours aged, 112.5 hours aged, and 125 hours aged). The relative solution viscosity values for the first example build material composition are shown in Table 2.

TABLE 2

| | Relative |
|---|---|
| Time aged | Solution |
| (hours) | viscosity |
| 0 | 1.54 |
| 12.5 | 1.52 |
| 25 | 1.55 |
| 37.5 | 1.54 |
| 50 | 1.55 |
| 62.5 | 1.54 |
| 75 | 1.55 |
| 87.5 | 1.58 |
| 112.5 | 1.57 |
| 125 | 1.56 |

As shown in Table 2, the relative solution viscosity (at 25° C.) of the first example build material composition remained substantially unchanged over time when exposed to 125° C. This indicates that that the first example build material composition has good reusability/recyclability. The relative solution viscosity values in Table 2 indicate that the first example build material composition may be reused/recycled without mixing the recycled build material composition with any fresh build material composition (i.e., 100% recycled build material may be used).

Additionally, the b* (i.e., blue-yellow) value at different weight ratios of recycled build material composition to fresh build material composition was measured over 10 generations of the first example build material composition. To produce the generations, fresh build material composition was aged in cycles. Each cycle aged the build material composition at 125° C. for 12.5 hours. The build material composition that was aged for: one cycle was aged for a total of 12.5 hours; two cycles was aged for a total of 25 hours; three cycles was aged for a total of 37.5 hours; four cycles was aged for a total of 50 hours; five cycles was aged for a total of 62.5 hours; six cycles was aged for a total of 75 hours; seven cycles was aged for a total of 87.5 hours; eight cycles was aged for a total of 100 hours; nine cycles was aged for a total of 112.5 hours; and ten cycles was aged for a total of 125 hours. Then, build materials compositions that been aged for different numbers of cycles were mixed together to simulate the mixing of fresh build material composition with the aged build material composition after each cycle.

To produce the first generation, build material composition that was aged for one cycle was mixed with fresh build material composition in the amount corresponding to the weight ratio of the different compositions. The 100% recycled build material composition (labeled “100% recycled”) was not mixed with any fresh build material composition; the 80:20 build material composition (labeled “80:20”) was mixed with 20% fresh build material composition; the 70:30 build material composition (labeled “70:30”) was mixed with 30% fresh build material composition; and the 60:40 build material composition (labeled “60:40”) was mixed with 40% fresh build material composition. The general formulation of each generation of the 100% recycled build material composition is shown in Table 3; the general formulation of each generation of the 80:20 build material composition is shown in Table 4; the general formulation of each generation of the 70:30 build material composition is shown in Table 5; and the general formulation of each generation of the 60:40 build material composition is shown in Table 6. The formulations in Tables 3-6 represent the percentage of each build material composition included in the generation. The build material compositions are identified in Tables 3-6 by the total number of hours for which they were aged.

TABLE 3

| | Total hours aged | | | | | | | | | | |
|---|---|---|---|---|---|---|---|---|---|---|---|
| | 0.0 | 12.5 | 25.0 | 37.5 | 50.0 | 62.5 | 75.0 | 87.5 | 100.0 | 112.5 | 125.0 |
| Fresh | 100 | 0 | 0 | 0 | 0 | 0 | 0 | 0 | 0 | 0 | 0 |
| Gen 1 | 0 | 100 | 0 | 0 | 0 | 0 | 0 | 0 | 0 | 0 | 0 |
| Gen 2 | 0 | 0 | 100 | 0 | 0 | 0 | 0 | 0 | 0 | 0 | 0 |
| Gen 3 | 0 | 0 | 0 | 100 | 0 | 0 | 0 | 0 | 0 | 0 | 0 |
| Gen 4 | 0 | 0 | 0 | 0 | 100 | 0 | 0 | 0 | 0 | 0 | 0 |
| Gen 5 | 0 | 0 | 0 | 0 | 0 | 100 | 0 | 0 | 0 | 0 | 0 |
| Gen 6 | 0 | 0 | 0 | 0 | 0 | 0 | 100 | 0 | 0 | 0 | 0 |
| Gen 7 | 0 | 0 | 0 | 0 | 0 | 0 | 0 | 100 | 0 | 0 | 0 |
| Gen 8 | 0 | 0 | 0 | 0 | 0 | 0 | 0 | 0 | 100 | 0 | 0 |
| Gen 9 | 0 | 0 | 0 | 0 | 0 | 0 | 0 | 0 | 0 | 100 | 0 |
| Gen 10 | 0 | 0 | 0 | 0 | 0 | 0 | 0 | 0 | 0 | 0 | 100 |

TABLE 4

| | Total hours aged | | | | | | | | | | |
|---|---|---|---|---|---|---|---|---|---|---|---|
| | 0.0 | 12.5 | 25.0 | 37.5 | 50.0 | 62.5 | 75.0 | 87.5 | 100.0 | 112.5 | 125.0 |
| Fresh | 100 | 0 | 0 | 0 | 0 | 0 | 0 | 0 | 0 | 0 | 0 |
| Gen 1 | 20 | 80 | 0 | 0 | 0 | 0 | 0 | 0 | 0 | 0 | 0 |
| Gen 2 | 20 | 16 | 64 | 0 | 0 | 0 | 0 | 0 | 0 | 0 | 0 |
| Gen 3 | 20 | 16 | 12.8 | 51.2 | 0 | 0 | 0 | 0 | 0 | 0 | 0 |
| Gen 4 | 20 | 16 | 12.8 | 10.24 | 40.96 | 0 | 0 | 0 | 0 | 0 | 0 |
| Gen 5 | 20 | 16 | 12.8 | 10.24 | 8.19 | 32.77 | 0 | 0 | 0 | 0 | 0 |
| Gen 6 | 20 | 16 | 12.8 | 10.24 | 8.19 | 6.55 | 26.21 | 0 | 0 | 0 | 0 |
| Gen 7 | 20 | 16 | 12.8 | 10.24 | 8.19 | 6.55 | 5.24 | 20.97 | 0 | 0 | 0 |
| Gen 8 | 20 | 16 | 12.8 | 10.24 | 8.19 | 6.55 | 5.24 | 4.19 | 16.78 | 0 | 0 |
| Gen 9 | 20 | 16 | 12.8 | 10.24 | 8.19 | 6.55 | 5.24 | 4.19 | 3.36 | 13.42 | 0 |
| Gen 10 | 20 | 16 | 12.8 | 10.24 | 8.19 | 6.55 | 5.24 | 4.19 | 3.36 | 2.68 | 10.74 |

TABLE 5

| | Total hours aged | | | | | | | | | | |
|---|---|---|---|---|---|---|---|---|---|---|---|
| | 0.0 | 12.5 | 25.0 | 37.5 | 50.0 | 62.5 | 75.0 | 87.5 | 100.0 | 112.5 | 125.0 |
| Fresh | 100 | 0 | 0 | 0 | 0 | 0 | 0 | 0 | 0 | 0 | 0 |
| Gen 1 | 30 | 70 | 0 | 0 | 0 | 0 | 0 | 0 | 0 | 0 | 0 |
| Gen 2 | 30 | 21 | 49 | 0 | 0 | 0 | 0 | 0 | 0 | 0 | 0 |
| Gen 3 | 30 | 21 | 14.7 | 34.3 | 0 | 0 | 0 | 0 | 0 | 0 | 0 |
| Gen 4 | 30 | 21 | 14.7 | 10.29 | 24.01 | 0 | 0 | 0 | 0 | 0 | 0 |
| Gen 5 | 30 | 21 | 14.7 | 10.29 | 7.20 | 16.81 | 0 | 0 | 0 | 0 | 0 |
| Gen 6 | 30 | 21 | 14.7 | 10.29 | 7.20 | 5.04 | 11.77 | 0 | 0 | 0 | 0 |
| Gen 7 | 30 | 21 | 14.7 | 10.29 | 7.20 | 5.04 | 3.53 | 8.24 | 0 | 0 | 0 |
| Gen 8 | 30 | 21 | 14.7 | 10.29 | 7.20 | 5.04 | 3.53 | 2.47 | 5.77 | 0 | 0 |
| Gen 9 | 30 | 21 | 14.7 | 10.29 | 7.20 | 5.04 | 3.53 | 2.47 | 1.73 | 4.04 | 0 |
| Gen 10 | 30 | 21 | 14.7 | 10.29 | 7.20 | 5.04 | 3.53 | 2.47 | 1.73 | 1.21 | 2.83 |

TABLE 6

| | Total hours aged | | | | | | | | | | |
|---|---|---|---|---|---|---|---|---|---|---|---|
| | 0.0 | 12.5 | 25.0 | 37.5 | 50.0 | 62.5 | 75.0 | 87.5 | 100.0 | 112.5 | 125.0 |
| Fresh | 100 | 0 | 0 | 0 | 0 | 0 | 0 | 0 | 0 | 0 | 0 |
| Gen 1 | 40 | 60 | 0 | 0 | 0 | 0 | 0 | 0 | 0 | 0 | 0 |
| Gen 2 | 40 | 24 | 36 | 0 | 0 | 0 | 0 | 0 | 0 | 0 | 0 |
| Gen 3 | 40 | 24 | 14.4 | 21.6 | 0 | 0 | 0 | 0 | 0 | 0 | 0 |
| Gen 4 | 40 | 24 | 14.4 | 8.64 | 12.96 | 0 | 0 | 0 | 0 | 0 | 0 |
| Gen 5 | 40 | 24 | 14.4 | 8.64 | 5.18 | 7.78 | 0 | 0 | 0 | 0 | 0 |
| Gen 6 | 40 | 24 | 14.4 | 8.64 | 5.18 | 3.11 | 4.67 | 0 | 0 | 0 | 0 |
| Gen 7 | 40 | 24 | 14.4 | 8.64 | 5.18 | 3.11 | 1.87 | 2.80 | 0 | 0 | 0 |
| Gen 8 | 40 | 24 | 14.4 | 8.64 | 5.18 | 3.11 | 1.87 | 1.12 | 1.68 | 0 | 0 |
| Gen 9 | 40 | 24 | 14.4 | 8.64 | 5.18 | 3.11 | 1.87 | 1.12 | 0.67 | 1.01 | 0 |
| Gen 10 | 40 | 24 | 14.4 | 8.64 | 5.18 | 3.11 | 1.87 | 1.12 | 0.67 | 0.40 | 0.61 |

The b* values for the build material compositions are shown in FIG. 5. In FIG. 5, the b* value is shown on the y-axis, and the generation number is shown on the x-axis. As shown in FIG. 5, the build material compositions yellow as the generation number increases, at least until the 6^{th} generation. The 100% recycled compositions continued to get more yellow as the generation number was increased. However, FIG. 5 shows that b* values of each of the 80:20 build material composition, the 70:30 build material composition, and the 60:40 build material composition plateaued at about the 6^{th} generation, and did not go above 8. This indicates that a 3D part with a desired color may be achieved with these compositions, even when recycled over and over again.

Additionally, the fresh build material composition and the first generation through tenth generation build material compositions at weight ratios of recycled build material composition to fresh build material composition of 80:20 were used to print several S2 specimens. Each of the S2 specimens was printed on a small testbed 3D printer with the example fusing agent (from Example 1), and 300 build material layers that were each about 100 μm thick.

The ultimate tensile strength and the elongation at break of these S2 specimens were measured using DIN standard 53504. The values for the ultimate tensile strength measurements are shown in FIG. 6A, and the values for the elongation at break measurements are shown in FIG. 6B. In FIG. 6A, the ultimate tensile strength (in MPa) is shown on the y-axis, and the S2 specimens are identified on the x-axis by fresh (i.e., fresh build material composition was used to form the S2 specimen) or the generation number of the build material composition used to form the S2 specimen. In FIG. 6B, the elongation at break (in %) is shown on the y-axis, and the S2 specimens are identified on the x-axis by fresh (i.e., fresh build material composition was used to form the S2 specimen) or the generation number of the build material composition used to form the S2 specimen.

FIGS. 6A and 6B show that the mechanical properties (i.e., ultimate tensile strength and elongation at break) of the S2 specimens formed from the first example build material composition do not trend downward as the generation number of the first example build material composition increases (i.e., the more the material is recycled). This indicates that the mechanical properties were unaffected by reusing/recycling the first example build material composition.

It is believed that the second example build material composition has a reusability/recyclability similar to the first example build material composition. As such, it is believed that the second example build material composition may be reused/recycled without mixing the recycled build material composition with any fresh build material composition (i.e., 100% recycled build material may be used). Additionally, it is believed that a desired color may be achieved at a weight ratio of recycled second example build material composition to fresh build material composition of 80:20. Further, it is believed that the mechanical properties of 3D part printed from the second example build material composition may be unaffected by reusing/recycling the second example build material composition.

It is to be understood that the ranges provided herein include the stated range and any value or sub-range within the stated range. For example, from about 1.55 to about 1.80 should be interpreted to include not only the explicitly recited limits of from about 1.55 to about 1.80, but also to include individual values, such as about 1.60, about 1.67, about 1.74, about 1.75, about 1.77 etc., and sub-ranges, such as from about 1.64 to about 1.76, from about 1.60 to about 1.70, from about 1.71 to about 1.79, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A three-dimensional (3D) printing kit, comprising:
a build material composition including a polyether block amide polymer; and
a fusing agent to be applied to at least a portion of the build material composition during 3D printing, the fusing agent including an energy absorber to absorb electromagnetic radiation to melt or fuse the at least a portion of the polyether block amide polymer.

2. The 3D printing kit as defined in claim 1 wherein the polyether block amide polymer has a relative solution viscosity at 25° C. ranging from about 1.55 to about 1.80, based on American Society for Testing Materials (ASTM) standards using m-cresol as solvent.

3. The 3D printing kit as defined in claim 1 wherein the polyether block amide polymer has a relative solution viscosity at 25° C. ranging from about 1.70 to about 1.80, based on American Society for Testing Materials (ASTM) standards using m-cresol as solvent.

4. The 3D printing kit as defined in claim 1 wherein the polyether block amide polymer has a relative solution viscosity at 25° C., after the polyether block amide polymer has been heated to 125° C. for up to 125 hours, ranging from about 1.55 to about 1.80, based on American Society for Testing Materials (ASTM) standards using m-cresol as solvent.

5. The 3D printing kit as defined in claim 1 wherein the polyether block amide polymer has a particle size ranging from about 7 μm to about 225 μm.

6. The 3D printing kit as defined in claim 1 wherein the polyether block amide polymer is a ground material.

7. The 3D printing kit as defined in claim 1, further comprising a detailing agent including a surfactant, a co-solvent, and water.

8. A method for three-dimensional (3D) printing, comprising:
applying a build material composition to form a build material layer, the build material composition including a polyether block amide polymer;
based on a 3D object model, selectively applying a fusing agent on at least a portion of the build material composition; and
exposing the build material composition to radiation to fuse the at least the portion to form a layer of a 3D part.

9. The method as defined in claim 8 wherein the selectively applying of the fusing agent is accomplished in multiple printing passes.

10. The method as defined in claim 8 wherein the exposing of the build material composition is accomplished in multiple radiation events.

11. The method as defined in claim 8 wherein the build material layer has a thickness ranging from about 70 μm to about 100 μm.

12. The method as defined in claim 8, further comprising, prior to the selectively applying of the fusing agent, pre-heating the build material composition to a pre-heating temperature ranging from about 110° C. to about 125° C.

13. The method as defined in claim 8 wherein the radiation has a wavelength ranging from 400 nm to 1400 nm.

14. The method as defined in claim 8, further comprising selectively applying, based on the 3D object model, a detailing agent on at least some of the at least the portion of the build material composition.

15. A three-dimensional (3D) printing composition, comprising:
a build material composition including a polyether block amide polymer; and
a fusing agent including an energy absorber to absorb electromagnetic radiation to melt or fuse at least the portion of the polyether block amide polymer in areas exposed to the fusing agent.
